(19) United States
(12) Patent Application Publication
(10) Pub. No.: US 2014/0334896 A1
(43) Pub. Date: Nov. 13, 2014

(54) REMOVABLE STUDS

(71) Applicant: Kevin Yang, Lomita, CA (US)

(72) Inventor: Kevin Yang, Lomita, CA (US)

(21) Appl. No.: 13/891,575

(22) Filed: May 10, 2013

(51) Int. Cl. F16B 39/282

(52) U.S. Cl. CPC F16B 39/282
USPC 411/166

(57) ABSTRACT

A removable stud has a stem having external machine thread formed on an exterior surface of the stem. A head extends from the external machine thread. The head has a profile for rotational interface. A base is connected to the stem. The base has a top base portion. A flange extends from the base. A lodging notch is formed on the flange. The lodging notch has a lodging notch sidewall. A front curve is formed on the base. The front curve has a radius of curvature that is coaxial to an axis of the stem. The front curve terminates at a flat stop. A bottom swivel is formed as a protrusion on a lower portion of the base. The bottom swivel has a center that is coaxial to an axis of the stem.

### FIELD OF THE INVENTION

The present invention is in the field of removable studs.

### DISCUSSION OF RELATED ART

Studs are commonly used for mounting and connecting electrical housing to household wiring. Studs provide mechanical connection for connecting together a variety of different electrical components when the electrical components have housing are to be connected to each other.

### SUMMARY OF THE INVENTION

A removable stud has a stem having external machine thread formed on an exterior surface of the stem. A head extends from the external machine thread. The head has a profile for rotational interface. A base is connected to the stem. The base has a top base portion. A flange extends from the base. A lodging notch is formed on the flange. The lodging notch has a lodging notch sidewall. A front curve is formed on the base. The front curve has a radius of curvature that is coaxial to an axis of the stem. The front curve terminates at a flat stop. A bottom swivel is formed as a protrusion on a lower portion of the base. The bottom swivel has a center that is coaxial to an axis of the stem.

A housing has a housing face with an open slot formed on it. The open slot is sized to receive a base within the open slot. A protrusion is formed on the housing having a protrusion edge that abuts to the lodging notch. The protrusion is sized to the lodging notch to prevent rotation after the lodging notch lodges to the protrusion when the stem is rotated from an open position to a lodged position. A gap is formed between an outside surface of the open slot and the removable stud when the removable stud is rotated to a lodged position. The housing further comprises a housing connection for connecting the housing to other articles. The housing further comprises a wire opening which comprises a conduit opening formed on an indent. The indent is formed on the housing face.

A slot base is formed as a portion of the housing face that was punched down to create the open slot. The slot base receives the removable stud when the removable stud is in an initial open position. The slot base protrusion receives a bottom swivel when the removable stud is placed in the open slot. The slot base protrusion and the bottom swivel cooperate to form a swivel connection relationship so that they swivel relative to each other when a user applies rotational force to the head. A front curve is formed on the base. The front curve has a radius of curvature that is coaxial to an axis of the stem.

The front curve terminates at a flat stop.

A bottom swivel is formed as a protrusion on a lower portion of the base. The bottom swivel has a center that is coaxial to an axis of the stem. A front curve is formed on the base. The front curve has a radius of curvature that is coaxial to an axis of the stem. The front curve terminates at a flat stop.

### BRIEF DESCRIPTION OF THE DRAWINGS

FIG. 1 is a perspective view showing the removable stud.

FIG. 2 is a perspective view of the removable studs installed on a housing.

FIG. 3 is a front perspective view of the present invention.

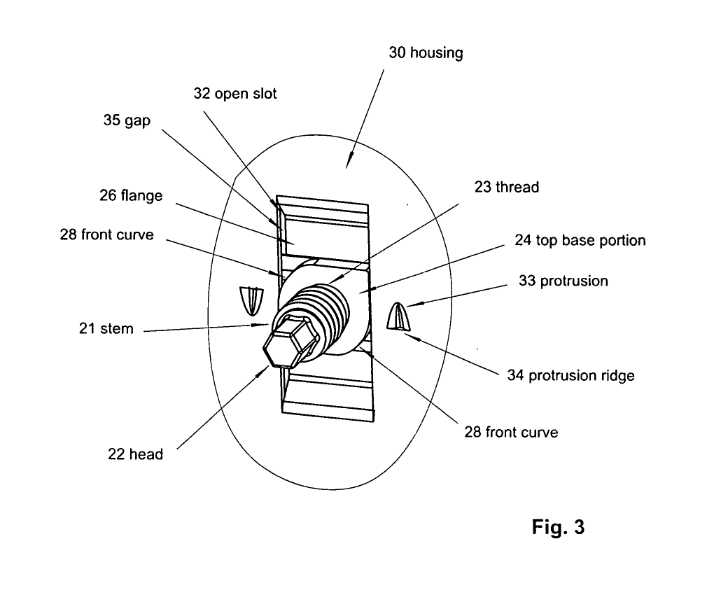

FIG. 4 is a rear perspective view of the present invention.

Any shading surface lines of the present invention are to show surface contour and shiny reflective metal surface finish.

The following call out list of elements is a useful guide in referencing the callout numbering of the drawings.
20 Stud
21 Stem
22 Head
23 Thread
24 Top Base Portion
25 Base
26 Flange
27 Lodging Notch
28 Front Curve
29 Flat Stop
30 Housing
31 Housing Face
32 Open Slot
33 Protrusion
34 Protrusion Edge
35 Gap
36 Slot Base
37 Slot Base Protrusion
39 Housing Connection
40 Wire Opening
41 Indent
42 Conduit Opening
88 Bottom Swivel

### DETAILED DESCRIPTION OF THE PREFERRED EMBODIMENT

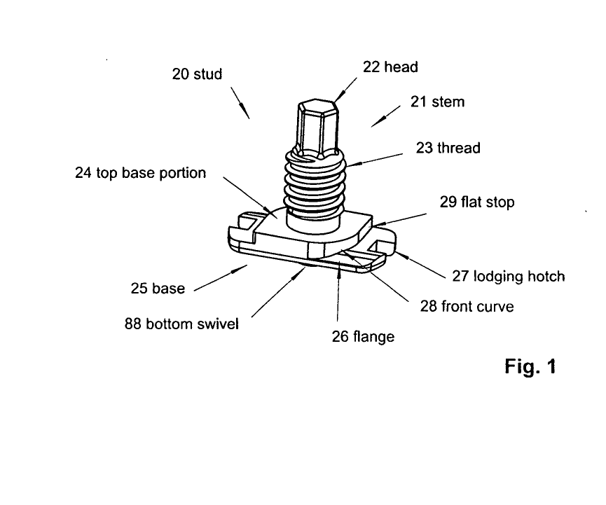

As seen in FIG. 1, the present invention is a removable electrical stud. Typically, a variety of different electrical components are mounted on a pair of studs. Sometimes the studs are needed and sometimes they are not. When the studs are not needed, the studs can be removed.

Generally, a stud 20 includes a stem 21. A head 22 extends outwardly from the stem 21. The head 22 can be hexagonal or have a Philips are Flathead interface. The head 22 is preferably rotated by a screwdriver that can have a hexagonal, Philips or other type of interface. The head is coaxial to the stem. The head and stem are preferably made of a lightweight metal that are integrally formed. The thread 23 is formed on an exterior portion of the stem and provides a surface for screw connection commonly required in electrical applications for connecting a first housing to a second housing for example. The head 22 is of smaller radius than the thread to allow the head to pass into a threaded aperture of a second housing.

The stem 21 extends from a base 25. The base has a top base portion 24 over a flange 26. The top base portion 24 is generally rectangular with a pair of front curves 28 that are cut out from the top base portion 24. Preferably, the front curve 28 terminates in a flat stop 29. The front curve 28 accommodates insertion into a slot, and the sidewall of the slot abuts the flat stop 29 when the stud is rotated into a locked position.

The front curve 28 has a radius of curvature that has a center coaxial to the axis of the stem and head. The flange 26 extends from a lower surface of the front curve 28 and the flat stop 29. The flange 26 is formed as a shelf with a cut out. The cutout is a lodging notch 27. The lodging notch 27 is preferably formed with the flange.

The base further includes a bottom swivel 88. The bottom swivel can be made as a protrusion extending from a generally flat plane of the flange. The protrusion can be hemispherical fitting into a slot base protrusion 37. The interaction between the bottom swivel 88 seated in the slot base protrusion 37 is preferably one of rotation. The slot base protrusion 37 and the bottom swivel 88 are coaxial to the center of the radius of curvature of the front curve 28 which is in turn coaxial to the central axis of the stem and head. The stud 20 is typically packaged separately in a small plastic bag with a wrench.

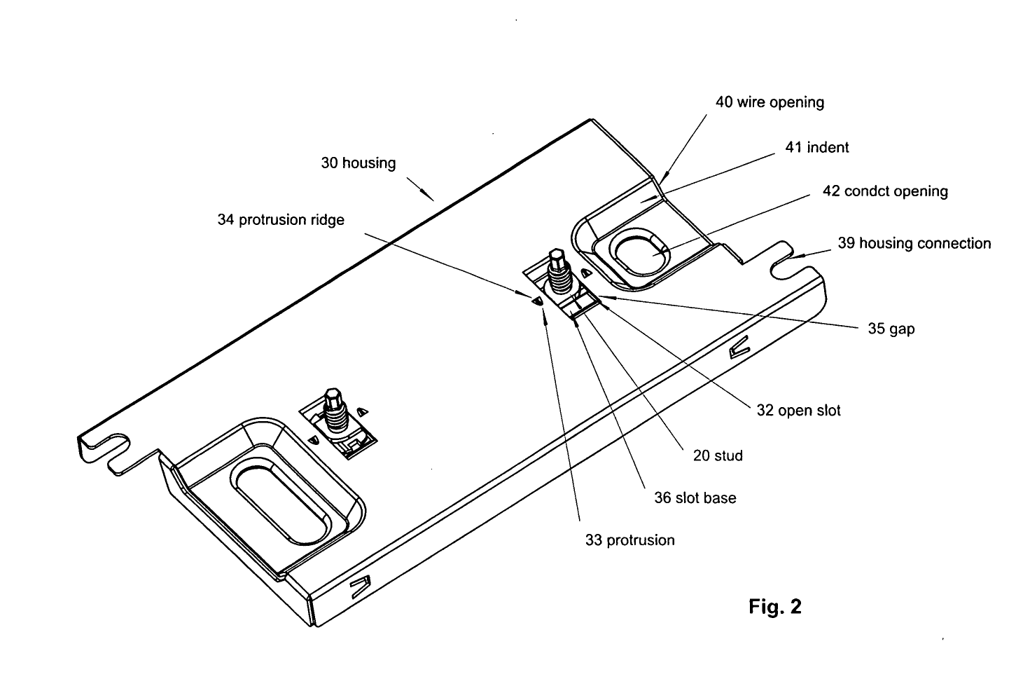

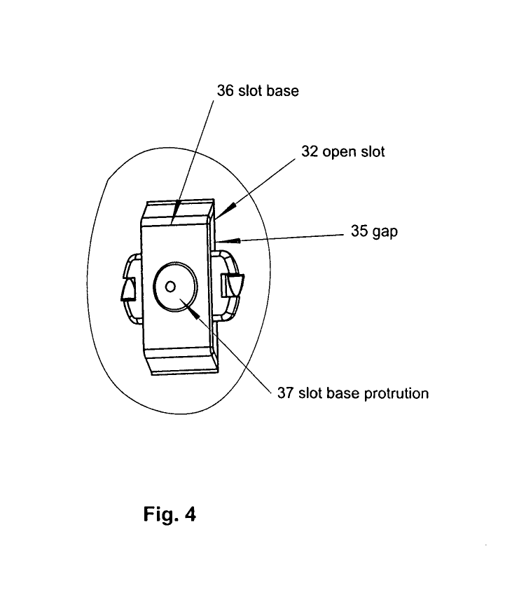

When a user needs to mount an electric housing 30 such as a ballast housing of a fluorescent lamp, a user inserts the stud into an open slot 32 is seen in FIG. 2. The open slot is formed by punching down a portion of the flat metal plate of the housing face 31. The open slot 32 is sized to receive the stud 20 when the stud 20 is in an open position. The user places the stud 20 on the open slot 32 and the stud 20 is supported at a bottom side of the stud by a slot base 36 which prevents the stud from falling into the housing 30 where it would be difficult to retrieve. The base of the stud has a bottom swivel protrusion 88. The bottom swivel protrusion 88 aligns the stud with the slot base at the slot base protrusion 37. If the bottom swivel protrusion 88 has a lower tip, it can lodge in the slot base protrusion 37. The slot base protrusion 37 protrudes on the bottom side of the slot base 36 as seen in FIG. 4, however, the slot base protrusion 37 is a cavity on the top side of the slot base 36. The slot base 36 has been pressed down to form the slot base cavity over the slot base protrusion 37. The slot base cavity receives the bottom swivel protrusion 88. The bottom swivel protrusion 88 can rotate relative to the slot base cavity.

When a user uses a wrench to turn the stud, the stud rotates in a clockwise direction for locking. The stud rotates 90° from an open position to a lodged position. The lodged position has a gap 35 between the stud 20 and the outside edge of the open slot 32. The gap represents the portion of the flange that has rotated underneath the face of the housing while the top base portion 24 remains exposed. The lodging notch 37 on the flange 26 lodges to a protrusion 33 and clicks onto a protrusion edge 34. The protrusion edge abuts the inside wall of the lodging notch 27 to prevent the rotation of the stud 20. The upper surface of the flange 26 presses against the inside surface of the housing face 31. The flange 26 may have a ramp that presses against the inside surface of the housing face 31.

The small form factor of the removable stud allows for close installation of other elements on the housing near the removable stud mounting location. The housing may have wires for electrical connection to other components near the removable stud mounting location. A wire opening 40 can be formed adjacent to the stud 20. The wire opening 40 can have an indent 41 and the indent 41 can have a conduit opening 42. In addition, housing connection 39 made of a groove can be formed relatively close to the removable stud mounting location.

It is preferred that the open slot is formed with a single punch press that cuts the edges of the open slot, presses down the slot base protrusion 36 and at the same time forms the protrusion 33 as well as the protrusion edge 34. The protrusion 33 is preferably arc shaped and having a parabolic profile that extends from a surface of the housing face 31. From the exterior of the housing 30, a user would see that the protrusion 33 protrudes inward into the housing face 31. Also, the slot base 36 would protruding inward into the housing face 31. It is preferred that an upper mold and a lower mold cooperate to form the protrusion and slot base in pairs. As seen in FIG. 2, a pair of removable studs are mounted in parallel at the proper standard stud distance location.

1. A removable stud comprising:
a. a stem having external machine thread formed on an exterior surface of the stem;
b. a head extending from the external machine thread, wherein the head has a profile for rotational interface;
c. a base connected to the stem, wherein the base has a top base portion;
d. a flange extending from the base;
e. a lodging notch formed on the flange, wherein the lodging notch has a lodging notch sidewall.

2. The removable stud of claim 1, further comprising: a front curve formed on the base, wherein the front curve has a radius of curvature that is coaxial to an axis of the stem.

3. The removable stud of claim 1, wherein the front curve terminates at a flat stop.

4. The removable stud of claim 1, further comprising: a bottom swivel formed as a protrusion on a lower portion of the base, wherein the bottom swivel has a center that is coaxial to an axis of the stem.

5. The removable stud of claim 1, further comprising: a housing having a housing face with an open slot formed on it, wherein the open slot is sized to receive a base within the open slot.

6. The removable stud of claim 5, a protrusion formed on the housing having a protrusion edge that abuts to the lodging notch, wherein the protrusion is sized to the lodging notch to prevent rotation after the lodging notch lodges to the protrusion when the stem is rotated from an open position to a lodged position.

7. The removable stud of claim 6, further comprising a gap formed between an outside surface of the open slot and the removable stud when the removable stud is rotated to a lodged position.

8. The removable stud of claim 6, wherein the housing further comprises a housing connection for connecting the housing to other articles.

9. The removable stud of claim 6, wherein the housing further comprises a wire opening which comprises a conduit opening formed on an indent, wherein the indent is formed on the housing face.

10. The removable stud of claim 6, further comprising: a slot base formed as a portion of the housing face that was punched down to create the open slot, wherein the slot base receives the removable stud when the removable stud is in an initial open position; and a slot base protrusion receiving a bottom swivel when the removable stud is placed in the open slot, wherein the slot base protrusion and the bottom swivel cooperate to form a swivel connection relationship so that they swivel relative to each other when a user applies rotational force to the head.

11. The removable stud of claim 6, further comprising: a front curve formed on the base, wherein the front curve has a radius of curvature that is coaxial to an axis of the stem.

12. The removable stud of claim 6, wherein the front curve terminates at a flat stop.

13. The removable stud of claim 6, further comprising: a bottom swivel formed as a protrusion on a lower portion of the base, wherein the bottom swivel has a center that is coaxial to an axis of the stem.

14. The removable stud of claim 13, further comprising: a front curve formed on the base, wherein the front curve has a radius of curvature that is coaxial to an axis of the stem.

15. The removable stud of claim 13, wherein the front curve terminates at a flat stop.
